(19) United States
(12) Patent Application Publication
(10) Pub. No.: US 2014/0055305 A1
(43) Pub. Date: Feb. 27, 2014

(54) ANTENNA APPARATUS INTEGRATING IN METAL SHELL

(71) Applicants: YEN-HUI LIN, New Taipei (TW); CHIEN-CHANG LIU, New Taipei (TW)

(72) Inventors: YEN-HUI LIN, New Taipei (TW); CHIEN-CHANG LIU, New Taipei (TW)

(21) Appl. No.: 13/692,945

(22) Filed: Dec. 3, 2012

(30) Foreign Application Priority Data
Aug. 27, 2012 (TW) 101130967

(51) Int. Cl. H01Q 1/22

(52) U.S. Cl. CPC H01Q 1/22
USPC 343/702

(57) ABSTRACT

An antenna apparatus includes a metal shell having a slit portion defining a slit, a circuit board received in the shell, and an antenna line formed on the circuit board including bended strip-shaped metal electrically connected to the slit portion. The slit portion is grounded. The circuit board is substantially perpendicular to the metal sidewall. The antenna line is electrically connected to the slit portion.

### BACKGROUND

1. Technical Field

The present disclosure relates to antennas, and particularly to an antenna apparatus integrating in a metal shell of an electronic device employing the antenna apparatus.

2. Description of the Related Art

Electronic devices employ metal shell to cover and accommodate circuit boards and antennas commonly. The metal shell is actually a shield which reduces efficiency of the antenna. Therefore, the electronic device is designed to avoid metal shell shield, which is more complicated and will increase cost. Furthermore, there is not enough space for allocating the metal shell and the antenna because of the size-miniaturization trend of the electronic device.

Therefore, there is room for improvement within the art.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a partially sectioned schematic view of an antenna apparatus, according to a first exemplary embodiment.

FIG. 2 is a partially sectioned schematic view of the antenna apparatus of FIG. 1, but viewed from another aspect.

FIG. 3 is a partially sectioned schematic view of the antenna apparatus, according to a second exemplary embodiment.

FIG. 4 is a partially sectioned schematic view of the antenna apparatus, according to a third exemplary embodiment.

FIG. 5 is a partially sectioned schematic view of the antenna apparatus, according to a fourth exemplary embodiment.

### DETAILED DESCRIPTION

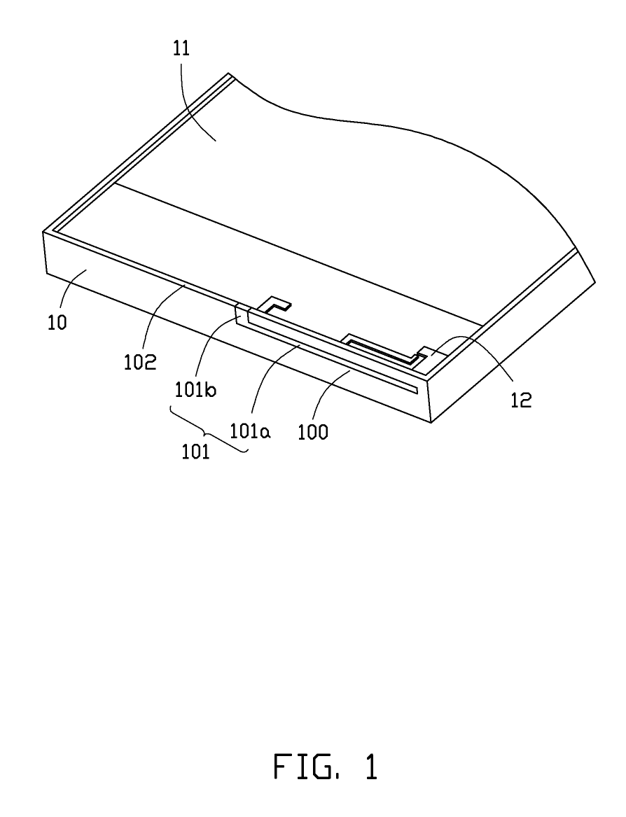

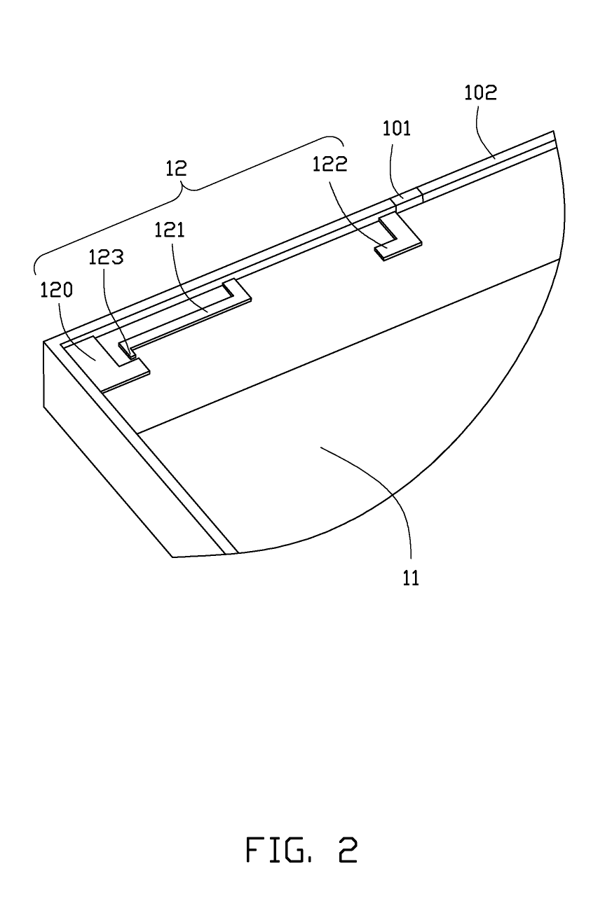

Referring to FIGS. 1 and 2, an antenna apparatus 1 includes a metal shell 10 of an electronic device (not shown), a circuit board 11 received in the shell 10, and an antenna line 12 formed on the circuit board 11.

The shell 10 includes a metal sidewall 100 having a slit portion 101 defining a slit being filled with a nonmetallic material. In the embodiment, the slit portion 101 is L-shaped including a first slit portion 101a and a second slit portion 101b. The first slit portion 101a extends along an edge 102 of the metal sidewall 100 adjacent to the circuit board 11, keeping a distance away from the edge 102, and the second slit portion 101b is perpendicular to the edge 102.

The antenna line 12 is formed on the circuit board 11. The antenna line 12 includes bended strip-shaped metal electrically connected to the metal sidewall 100. The metal sidewall 100 is grounded, namely, the slit portion 101 is grounded, which results in integrating the antenna line 12 with the slit portion 101 to be an antenna. In the embodiment, a distal end of the antenna line 12 is electrically connected to the slit portion 101. In an alternative embodiment, a central point of the antenna line 12 is electrically connected to the slit portion 101. In the embodiment, the antenna line 12 includes a grounded strip 120, a connecting strip 121, and an extension strip 122. The grounded strip 120 is connected to the metal sidewall 100. A feed point 123 is formed where the connecting strip 121 adjacent to the grounded strip 120, and the connecting strip 121 is connected between the feed point 123 and the metal shell 100. The extension strip 122 is configured for being turned to change frequency of the antenna apparatus 10.

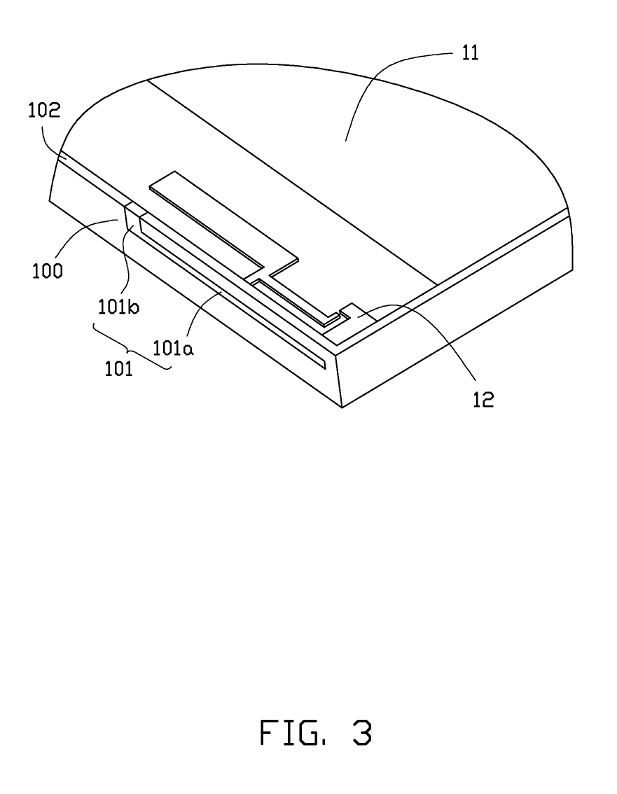

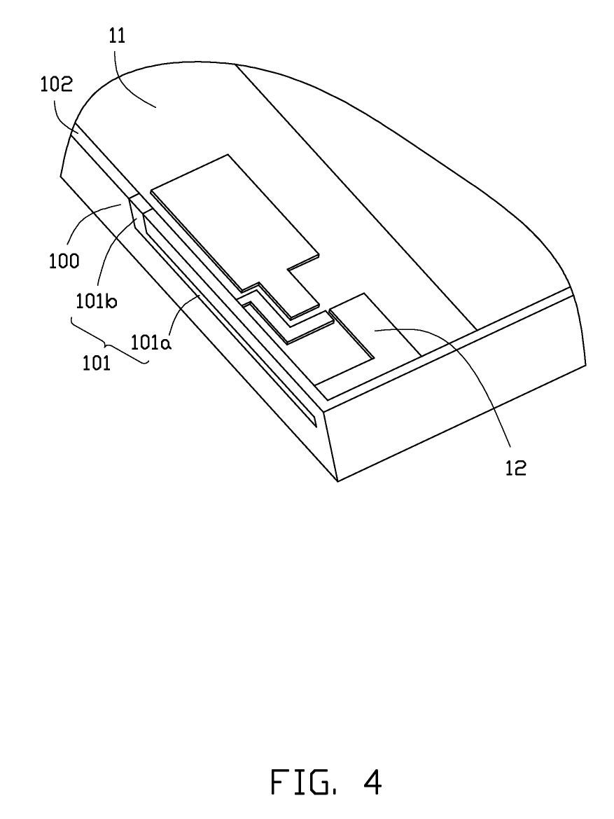

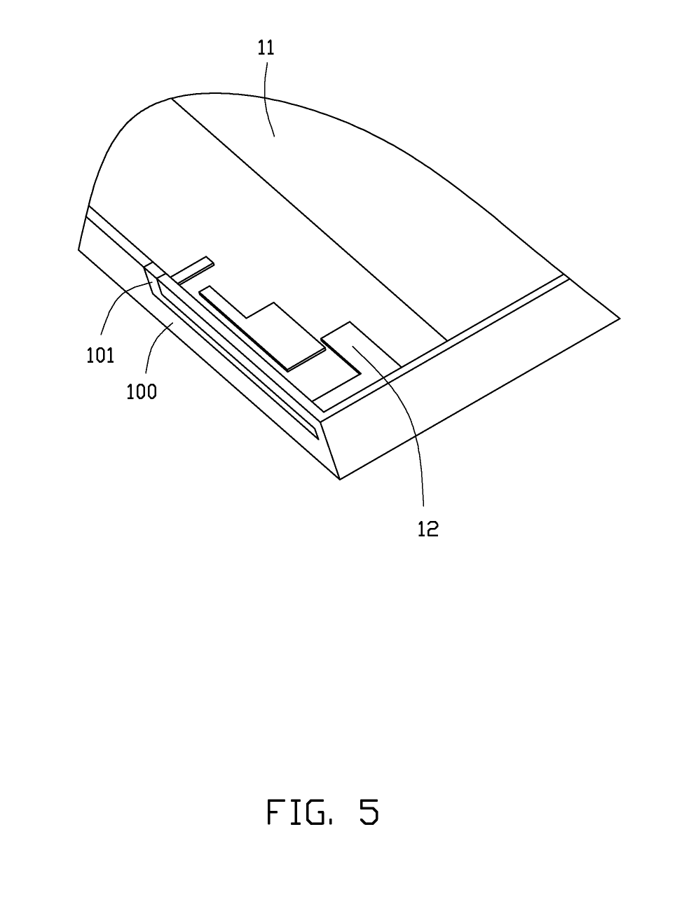

Referring to FIGS. 3-5, the antenna line 12 can be formed on the circuit board 11 as shown. The shape, size and location of the antenna line 12 can be changed so as to change the broadband and the efficiency of the antenna apparatus 1.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. An antenna apparatus comprising:
a metal shell comprising a metal sidewall having a slit portion defining a slit, the slit portion being grounded;
a circuit board received in the shell and substantially perpendicular to the metal sidewall; and
an antenna line formed on the circuit board, the antenna line including bended strip-shaped metal electrically connected to the slit portion.

2. The antenna apparatus as recited in claim 1, wherein the slit portion comprises a first slit portion and a second slit portion connected with each other, the first slit portion extends along an edge of the metal sidewall adjacent to the circuit board, keeping a distance away from the edge, and the second slit portion is perpendicular to the edge.

3. The antenna apparatus as recited in claim 1, wherein a distal end of the antenna line is electrically connected to the slit portion.

4. The antenna apparatus as recited in claim 1, wherein a central point of the antenna line is electrically connected to the slit portion.

5. The antenna apparatus as recited in claim 1, wherein the slit is filled with a nonmetallic material.

6. The antenna apparatus as recited in claim 1, wherein the antenna line comprising:
a grounded strip connected to the metal sidewall;
a connecting strip connected between the metal shell and a feed point formed where the connecting strip adjacent to the grounded strip; and
an extension strip configured for being turned to change frequency of the antenna apparatus.
